(19) United States
(12) Patent Application Publication
(10) Pub. No.: US 2003/0158733 A1
(43) Pub. Date: Aug. 21, 2003

(54) Character type speak system

(76) Inventors: Toshiya Nonaka, Saitama-ken (JP); Jun Takama, Tokyo (JP); Yasunori Nakagawa, Tokyo (JP); Yoshi Ishizaki, Tokyo (JP); Takeo Suzuki, Tokyo (JP)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/099,294

(22) Filed: Mar. 13, 2002

(30) Foreign Application Priority Data
Mar. 13, 2001 (JP) P2001-070961

(51) Int. Cl. G10L 15/00

(52) U.S. Cl. 704/255

(57) ABSTRACT

A character type speak system is disclosed as including a meaning network database 10, an SDD module 20 for producing a string of free sentences, a standardized topic module 30 which allows a conversation to be performed on a particular topic, and an interconnection module 40 which enables continuous deployment of the conversation while maintaining and managing a discourse connecting property between the SDD module 20 and the standardized topic module 30. As such, the speak system (speak robot) per se realizes an autonomy and the discourse connecting property as a discourse participant.

### BACKGROUND OF THE INVENTION

The present invention relates to a character type speak system to be applied to, for example, a speak robot.

In general, it has heretofore been proposed to provide a speak robot (speak system) which is able to have a given conversation with a user and which is generally classified into four categories, i.e. an interruptive type speak system, a stimulus-response type speak system, a query type speak system and a standardized-sentence database type speak system.

Among these systems, the interruptive type speak system is prepared with speak points at various areas of a certain speak flow to allow the user to select a response with YES/NO or a selective form, with a progress in flow of speak being determined on the basis of information selected by the user.

Further, the stimulus-response type speak system is arranged to sense or recognize a physical contact effectuated by a sensor, a timer or the user for thereby allowing a limited number of standardized utterances of a string of speech to be initiated.

Furthermore, the query type speak system is arranged to analyze a frame element and a construction of a query sentence prepared by the user, to extract the most relevant information from a database and to return it to the user.

In addition, the standardized sentence database type speak system incorporates a database which stores a limited number of speech sentences with fixed forms of which a particular sentence is returned to the user in response to an external input under a given condition.

However, any of such state-of-the-art speak robots (speak systems) has a large limitation in a topic range to be responded, a response form and a progress form in the speak flow, etc. For example, since the query type speak system has a limit in the knowledge range to be analyzed and the response forms of the robot, this system is in practical use only in a search robot to allow a particular knowledge to be searched. Besides, at the first glance, although the stimulus-response type speak system seems to be a robot which voluntarily responds to the user, this system operates only on a program to allow a particular speech sentence to be kicked off on condition of a particular stimulus. Thus, there is no conversation in linguistic communication between the user and the robot in the above speak system, and the speak system merely is nothing more than a robot which experiences a regular response with respect to the external stimulus. The largest causes that form such limits seem to rely on an essential nature of unified speaking activity (hereinafter referred to as a “discourse”).

A human discourse per se is an extremely dynamic activity and, also, speakers who participate in the discourse fall in charge of progressing the discourse in autonomy. That is, plural speakers having autonomy construct a dynamic flow on a real time basis. But, on the other hand, such a dynamic discourse flow should not be in disorder and there should be a certain relevance between fore and aft portions of the discourse flow. The relevance (hereinafter referred to as a connecting property or united property) between such fore and aft portions of the discourse flow forms an extremely important factor. Thus, when realizing active movement of a human discourse using the speak robot (speak system), it is an important key for the speak robot (speak system) to ensure and realize the autonomy and the discourse connecting property as the discourse participant.

Either one of these state-of-the-art speak robots (speak systems) classified into four categories undergoes an issue with a function which has no autonomy and desired discourse connecting property as such a discourse participant.

### SUMMARY OF THE INVENTION

It is an aim of the present invention to exclude various points at issue encountered in the state-of-the-art speak systems and has an object of the present invention to provide a character type speak system which has a structure to compel the speak system (speak robot) per se to enable realization of an autonomy and a discourse connecting property as a discourse participant whereby the speak system is able to learn a knowledge system related to a user through a string of speech with the user for growing up a particular character that copes with the user's uttered content and is enabled for a conversation to be performed while independently developing and deploying topics in dependence on the user's reaction, the content of the uttered speech, a string of words used and timings of utterance.

In order to achieve the above object, an aspect of the present invention concerns a character type speak system using a computer which allows a characteristic conversation with a user to be performed, comprising a meaning network database which stores a large number of words, an SDD module which produces a string of free sentences, a standardized topic module which allows a conversation to be deployed on a particular topic, and an interconnection module which enables a continuous deployment of the conversation while maintaining and managing a discourse connecting property between the SDD module and the standardized topic module.

In the character type speak system, the meaning network database includes a noun table and a predicate table and has a given connecting property between words meaningfully correlated to one another.

In the character type speak system, the SDD module preliminarily contains a list of a plurality of kinds of sentence patterns and has a constraint function with respect to a discourse grammar in each language wherein, when producing an utterance sentence by embedding a noun or verb, necessary for an arbitrary topic, into an arbitrary sentence pattern, established information is omitted to preclude the presence of the same in the sentence.

In the character type speak system, the standardized topic module has a structure wherein stepwise information depths are allocated to a plurality of individual topics, and a plurality of response sentences are prepared in the stepwise information depths, respectively.

In the character type speak system, the interconnection module has a hedge function for ensuring a connecting property between a user's utterance sentence and a robot's response sentence.

The character type speak system further comprises a user information management module and a character management module.

### BRIEF DESCRIPTION OF THE DRAWINGS

FIG. 1 is a block diagram illustrating a character type speak system of a preferred embodiment according to the present invention;

FIG. 2A is a flow chart (¼) illustrating the basic sequence of speak operation in the system shown in FIG. 1;

FIG. 2B is a flow chart (2/4) illustrating the basic sequence of speak operation in the system shown in FIG. 1;

FIG. 2C is a flow chart (¾) illustrating the basic sequence of speak operation in the system shown in FIG. 1;

FIG. 2D is a flow chart (4/4) illustrating the basic sequence of speak operation in the system shown in FIG. 1;

FIG. 3A is a table (½) illustrating the content of an interconnection module of an SDD forming part of the speak shown in FIG. 1;

FIG. 3B is a table (2/2) illustrating the content of an interconnection module of an SDD forming part of the speak shown in FIG. 1;

FIG. 4A is a table (½) illustrating a hedge connection in the SDD forming part of the speak system shown in FIG. 1; and

FIG. 4B is a table (2/2) illustrating a hedge connection in the SDD forming part of the speak system shown in FIG. 1.

### DETAILED DESCRIPTION OF THE PREFERRED EMBODIMENT

To describe the present invention more in detail, a character type speak system of a preferred embodiment according to the present invention will be described below in detail with reference to the drawings.

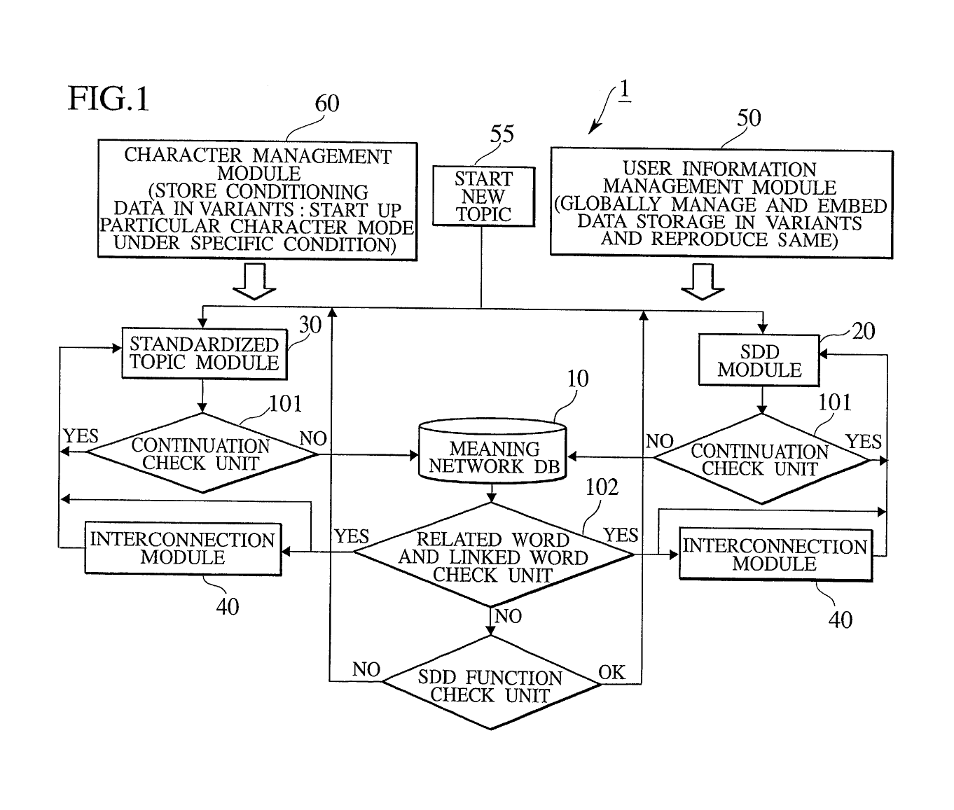

Referring now to FIG. 1, there is shown a character type speak system 1 of the preferred embodiment according to the present invention. The character type speak system 1 includes a system using a computer that enables to have a conversation with a characteristic with a user. Although an outer appearance of the character type speak system is not shown in the drawing, the character type speak system 1 may be formed in structure as a man type robot, a robot-like pet similar to an animal and other types of robots in any arbitrary configuration.

The character type speak system 1 is comprised of a meaning network data base 10 which has a large stock of vocabularies, an SDD (Speak Driven Discourse) module 20 which generates a string of free sentences, a standardized topic module 30 which allows the synthesized human speech to be deployed on particular topics, and an interconnection module 40 which enables continuous deployment of a string of conversations while maintaining and managing a discourse connecting property between the SDD module 20 and the standardized topic module 30. The character type speak system 1 further includes a user information management module 50 and a character management module 40.

As shown in FIG. 1, the character type speak system 1 is further comprised of a continuation check unit 101, a related word and linked word check unit 102, and an SDD (Speak Driven Discourse) function check unit 103.

The meaning network database 10 is registered with a string of approximately 5000 words together with associated pronunciation and grammatical information and includes a noun table and a predicate table. The noun table has classified field categories which include target nouns, linked nouns, higher rank concepts, lower rank concepts, associated words, predicates, a part of speech information, attribute information, etc. Also, the predicate table has classified categories which include target predicates, predicate nouns, antonyms, linked nouns, a part of speech information, attribute information, etc.

The meaning network database 10 plays an extremely major role in execution of the other modules 20 to 60. That is, while there is a need for specific syntactic constraints to be imposed in order to realize the production of a string of sentences in deployment, returning, development and connecting property of particular topics, the presence of the meaning network database 10 per se having the connecting property to some extents compels it to serve as an optimum knowledge management database suited for realization of aims of such character type speak system 1.

The SDD module 20 serves to allow the character type speak system 1 to enhance an autonomy and, to this end, serves to realize the supply of various topics in a voluntary manner while realizing a function to reproduce a string of free sentences depending upon user's response. For this reason, the SDD module 20 has a function to store deployment pattern information of human discourse activity from which an optimum pattern is selected in dependence on status quo in a string of particular conversation to allow the conversation to be deployed on the basis of selected optimum pattern.

That is, the SDD module 20 aims to maximize in taking advantage of characteristic features in a discourse grammar in each language for realizing an autonomy discourse function in minimum discourse constraint conditions in a manner as will be described below. In general, there is a characteristic limit in the discourse grammar in Japanese language wherein established information is omitted to preclude the same from being expressed in the string of sentences. Namely, when a particular topic and a listener are fixed once, there is no need for a listener's title and the topic to be expressed as will be indicated in the following string of speech:

A: (Did you) go (to your) company yesterday?

B: Yes, I went (to my company).

A: Are you exhausted (in your job)?

B: So-so.

A: (Did you) have overtime work?

B: No.

As will be appreciated from the above example of the string of speech, once a particular topic of the human speech has been identified such as “to whom such a particular topic is related”, Japanese conversational grammar need not specify such a particular human with a pronoun as in English in a subsequent conversation process. Further, once a particular topic (such as “company”) has been identified, remaining other information (for example, “overtime work”) contained the string of the speech is examined for its relationship and genuineness in the context of a topic framework (a framework for knowledge) as nearly close to an intended content as possible. In this respect, at a time when A asked B about “overtime work?”, B replies to A on the basis of judgment in that “he should have asked me whether I had overtime work in my company”. That is, in Japanese language, at the time when a particular topic and a participant are identified to establish a certain level of communized knowledge, there is a mechanism for a deficient information part, which does not appear in the string of speech, to be understood by respective participants with their compensations in understanding.

The SDD module 20 achieves the discourse deployment basically applied with such a mechanism and analyzes a discourse progressing process into a new deployment part to permit recognition of a new topic and a new participant and a control part to allow a desired conversation to be continued on the basis of established information. Upon such analysis, the SDD module 20 compels a system (robot) to secure conditions needed for a new deployment process and an established information deployment process, thereby providing an ability of realizing a natural speech to be undertaken at “an approximate quantity value”. Namely, there is a mechanism wherein if minimal discourse requirements for the respective processes are secured, then, users unconsciously try to compensate and understand deficient information and related information, with such a mechanism being effectively applied in the character type speak system 1 of the preferred embodiment.

By the way, the string of human discourse does not necessarily transits in a fixed activity (speed) and, in the course of communication on particular topics, the activity tends to be rather lowered to cause information domain to be narrowed to increase information depth. Namely, the sentence production activity and information depth have an inversely proportional relationship with respect to one another. Among these, the activity is secured in the SDD module 20 and, on the other hand, the standardized topic module 30 is prepared for enhancing information depth. As a result, the standardized topic module 30 is input with various degrees of information depth related with a plurality (more than 40) of individual topics, with a plurality of reacting sentences being prepared in terms of respective information depths. And, combining the SDD module 20 and the standardized topic module 30 allows the discourse activity and information depth, which are antithetical to one another, to be simultaneously ensured and realized.

The interconnection module 40 marks a discourse connecting property, which maintains and manages continuous deployment of the string of speech, such that the discourse connecting property is classified into four levels in the order of narrowness of the domain: (i) a syntax and semantic connecting property within the same sentence, (ii) a connecting property between the string of words which the user has uttered and a string of sentences responded by the robot, (iii) a connecting property between a particular topic in the discourse and associated sentences which are uttered, and (iv) a connecting property between established user's information and an on-the-spot utterance reproduced by the robot.

Among these levels, (i) the syntax and semantic connecting property within the same sentence is for a sentence form freely produced by the robot. In the character type speak system 1, a grammatical construction in Japanese language is analyzed to allow the SDD module 20 to produce a sentence in a subject and predicate construction, thereby ensuring the syntax connecting property. With such operation, the string of words, stored in the meaning network database 10 while retaining the connecting property, are reflected on the sentence without destroying its semantic united property. Also, the predicate that needs an antecedent, i.e. “+human”, as a subject noun, is marked with a flag representative of “+human” within database to squeeze a mutual relationship in the subject and predicate.

Further, (ii) the connecting property between the string of words, which the user has uttered, and the string of sentences, responded by the robot, is realized by a hedge management. That is, the “hedge” refers to an action to produce an utterance as a “binder” or a “pillow word” prior to an utterance involving a substantial content and plays an important roll for maintaining the discourse connecting property. Namely, the robot is arranged not to produce utterance directly after the string of words uttered by the user but to insert phrases for confirming, sympathizing with and traversing an attitude with respect to user's proposition and then to allow utterance of a string of words to be continued, embedding a differential step between the adjacent words to secure the connecting property. To achieve this end, the character type speak system 1 executes the hedge management to provide a suitable reaction in response to the user's reaction within the SDD module 40, within the standardized topic module 30, within the interconnection module 40 or among these component parts.

Furthermore, (iii) the connecting property between the particular topic in the discourse and the associated sentences that are uttered is realized in a concept of a topic management technology. Namely, in a case where a precedent topic is present, the character type speak system 1 is arranged to provide a limitation to prevent an appearance of new information words that get ahead of the preceding topic.

Moreover, (iv) the connecting property between established user's information and the on-the-spot utterance reproduced by the robot is realized under the presence of an user information learning function that stores and maintains the content, an uttering attitude and information of words previously uttered by the user as a log, and a produced sentence management log function that stores and maintains information uttered by the robot. Namely, in the character type speak system 1, the user information management module 50 has a user information learning function, and the character management module 60 has a produced sentence management log function. With such functions, a knowledge established in past string of speeches executed between the user and the robot is reflected in a subsequent string of speeches.

Further, the character type speak system 1 has two kinds of functions to perform the formation of characters, i.e., one function to allow dynamic expression of a particular character that is kicked out by a keyword and the other function to allow expression of a particular character on the basis of static data of the user's reaction that are stored. Among these functions, in the former function, a particular string of words uttered by the user form keywords to allow characters, corresponding to those of the type of the utterance produced by the user, to be realized in a string of words uttered by the robot. For example, these include “a volley of gags” or “an abuse return”. Also, the latter one includes a function to allow a particular string of characters to appear at a given number of frequency at various points of the words when the knowledge managed by the user information learning function satisfies a given condition. This is principally achieved by the character mode management function, and for example, when the user uses particular words corresponding to “a paternal word group” many times, the robot also tends to enter into “the paternal mode” at the high frequency.

On the other hand, the dynamic character is expressed in a time control function. For example, in a case where a time schedule including the hour of rising inputted by the user is ignored, an utterance of a string of words with a particular sentimental tincture is selected.

Arranging these characters to be synchronized with expression provided on a display at a face portion of the robot allows an impression to be strongly imposed to the user. That is, though not shown, when structuring the character type speak system 1 as a robot in an arbitrary configuration such as a human shape and a pet-like shape, it is preferable for the expression of the robot to be provided by an LCD device and for the sentiment of the robot to be provided to the user with an LED device.

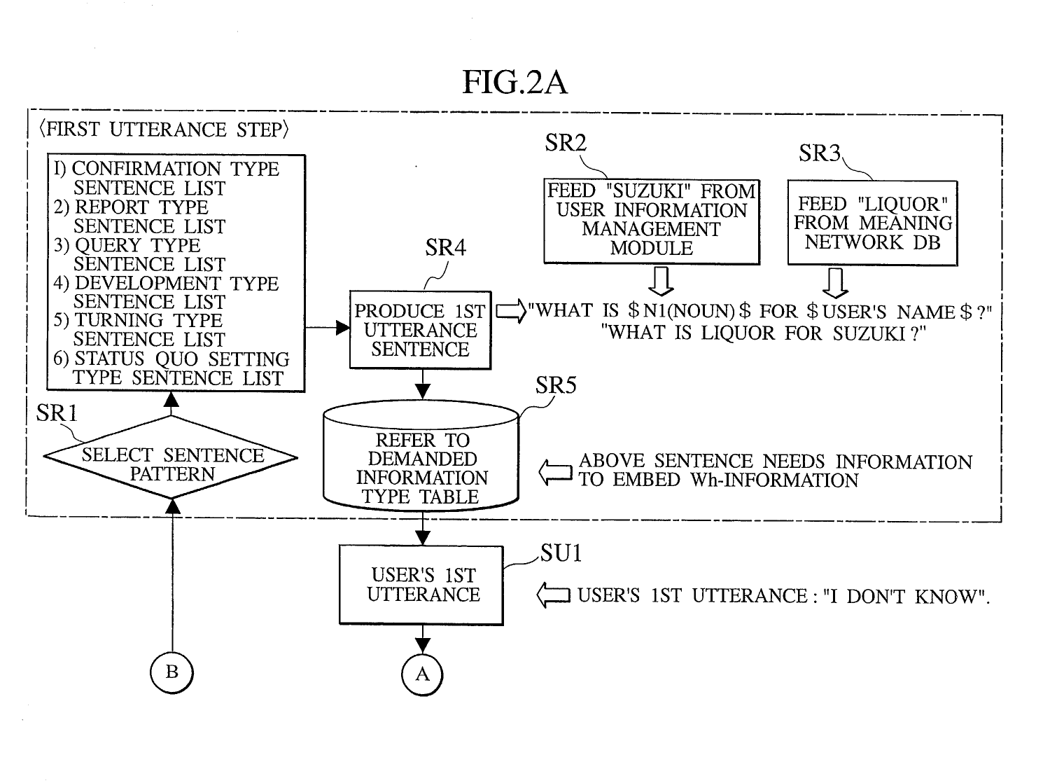

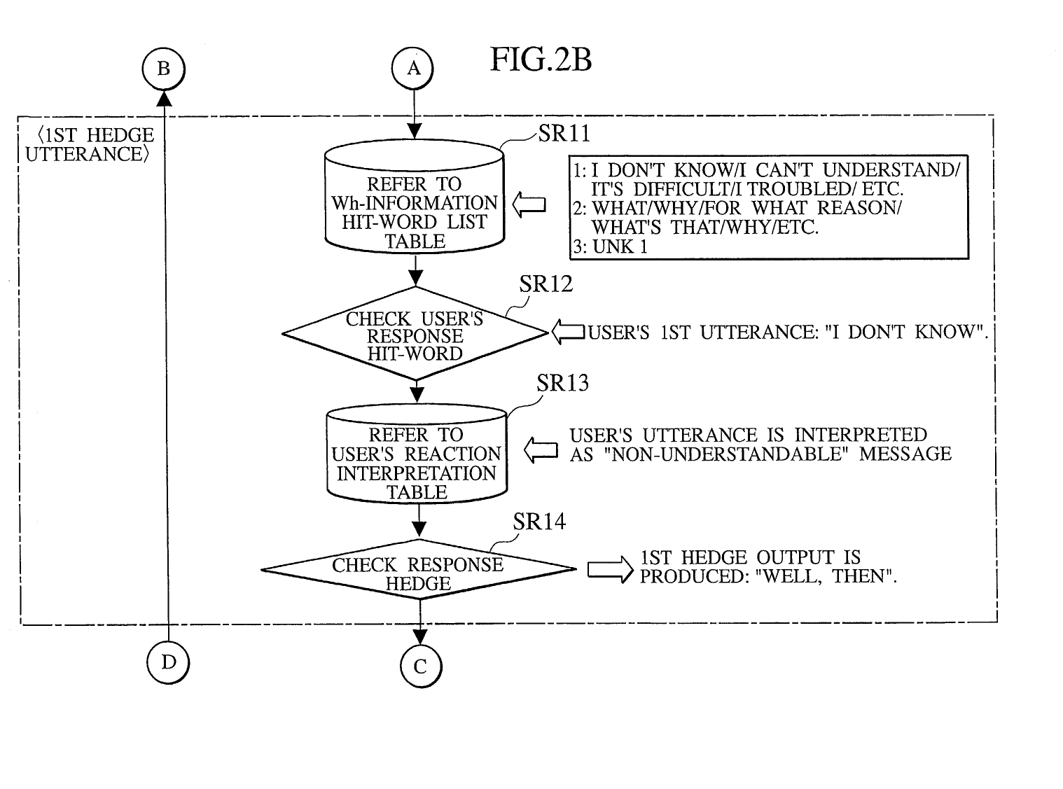

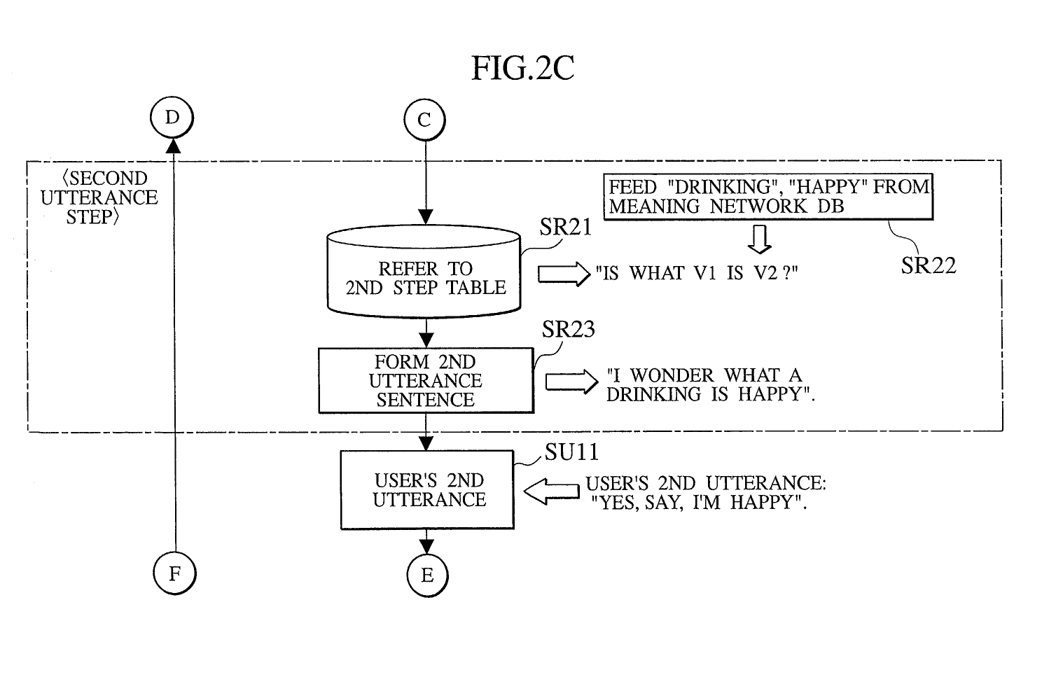

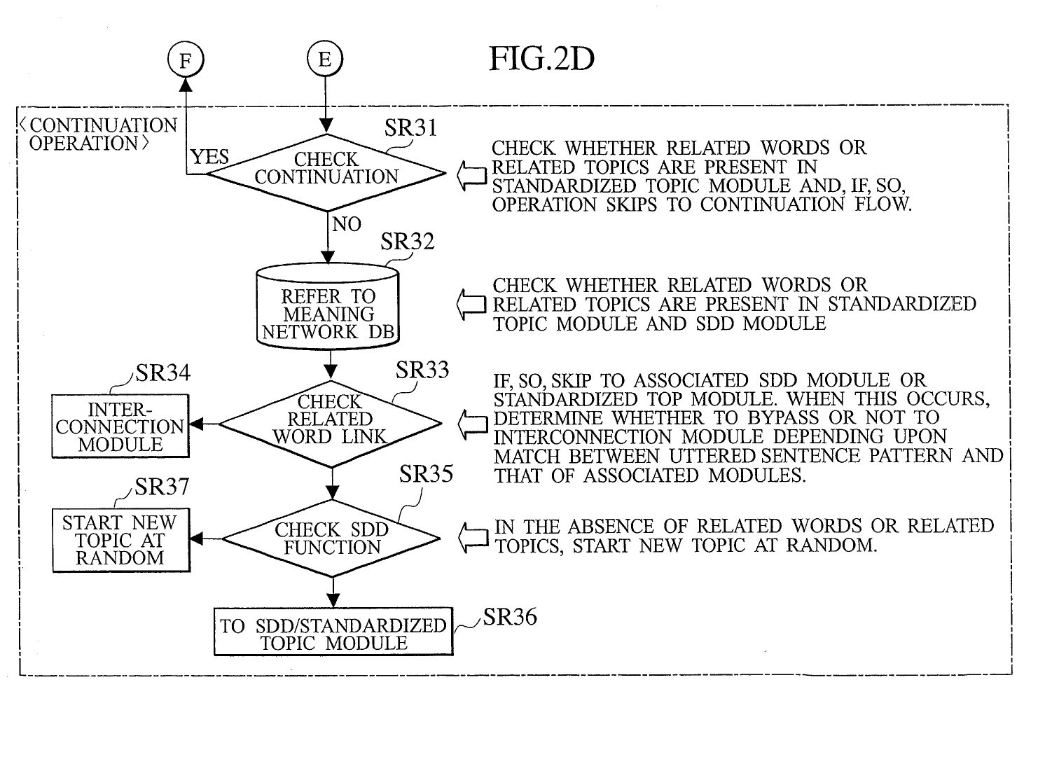

Now, an operation of the character type speak system 1 of the preferred embodiment is described below in detail with reference to a flow chart shown in FIGS. 2A, 2B, 2C and 2D.

In an example shown in FIGS. 2A, 2B, 2C and 2D, a string of speech is advanced in a first utterance step, a first hedge step, a second utterance step and a continuing step.

In the first utterance step, initially, the SDD module 20 selects (3) a query type sentence list from among (1) a confirmation type sentence list, (2) a report type sentence list, (3) the query type sentence list, (4) a development type sentence list, (5) a turning type sentence list and (6) a status quo setting type sentence list and, in step SR1, selects a sentence pattern “What is $ N1 (noun) $ for $name of user $?”.

In subsequent step SR2, the SDD module 20 takes the word “Suzuki” from the user information management module 50 and embeds it to the user's name in the selected sentence pattern. Further, the word “liquor” is taken out from the meaning network database 10 and is embedded into N1 (noun) in the sentence pattern. Consequently, in step SR4, the SDD module 20 produces a sentence “What is liquor for Suzuki?” to allow the same sentence to be uttered by the robot. When this occurs, in step SR5, the SDD module 20 refers to a demanded information type table for recognizing that the above string of sentence to be uttered is equal to the sentence of the type that needs information that embeds Wh-information.

In response to such first utterance, in step SU1, for example, the user replies “I don't know”.

Then, on the basis of the above demanded information type recognition in the SDD module 20, the interconnection module 40 refers to a Wh-information hit list table in step SR11, checks a user's response hit-word in step SR12, refers to a user's response interpretation table in step SR13 and interprets that the user's first utterance “I don't know” is a “non-understandable” message. And, the SDD module 20 checks a response hedge in step SR14, allowing a first string of hedge utterance “Well” to be produced by the robot as a hedge output.

In consecutive step SR21, the SDD module 20 refers to a second step connection table, selects a sentence pattern “Is what V1 (verb) is V2 (verb)?”, takes the words “drinking” and “happy” having the semantic connecting property with the word “liquor” from the meaning network database 10, embeds these words into V1 and V2 (verbs) in step, respectively, in step SR22 for producing a string of sentence “Is it happy in drinking” in step SR23 to be uttered by the robot.

In response to such second utterance, the user replies “Yes, say, it's happy” in step SU11.

Then, in step SR31, the continuation check unit 101 checks whether the related words or the related topics are present in the standardized topic module 30 and, in such case, the operation goes to a continuation flow.

In case of absence of such words, the operation goes to step SR32 where the meaning network database 10 is referred to for checking whether the related words or the related topics are present in the standardized topic module 30 or in the SDD module 20.

And, in step SR33, the related word and link word check unit 102 checks the related words and, when they are found to be present, the operation flow goes to the associated standardized topic module 30 or SDD module 20. When this occurs, in step SR34, determination is executed whether to bypass or not to bypass the interconnection module 40 depending on the match between the uttered sentence pattern in the second uttered step and that of the associated modules.

Consecutively, in step SR35, the SDD function check unit 103 executes checking of the SDD function. In the presence of the related words and the related topics, in step SR36, the operation flow is transferred from the standardized topic module 30 to the SDD module 20. On the contrary, in the absence of the related words and the related topics, in step SR37, new topics are started at random.

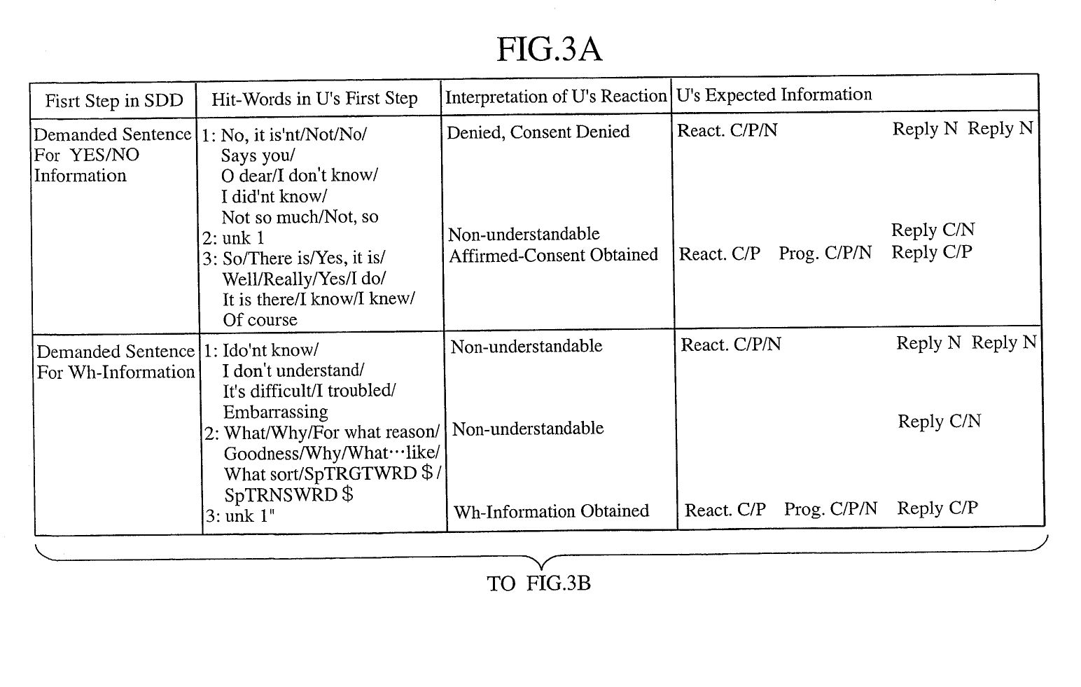

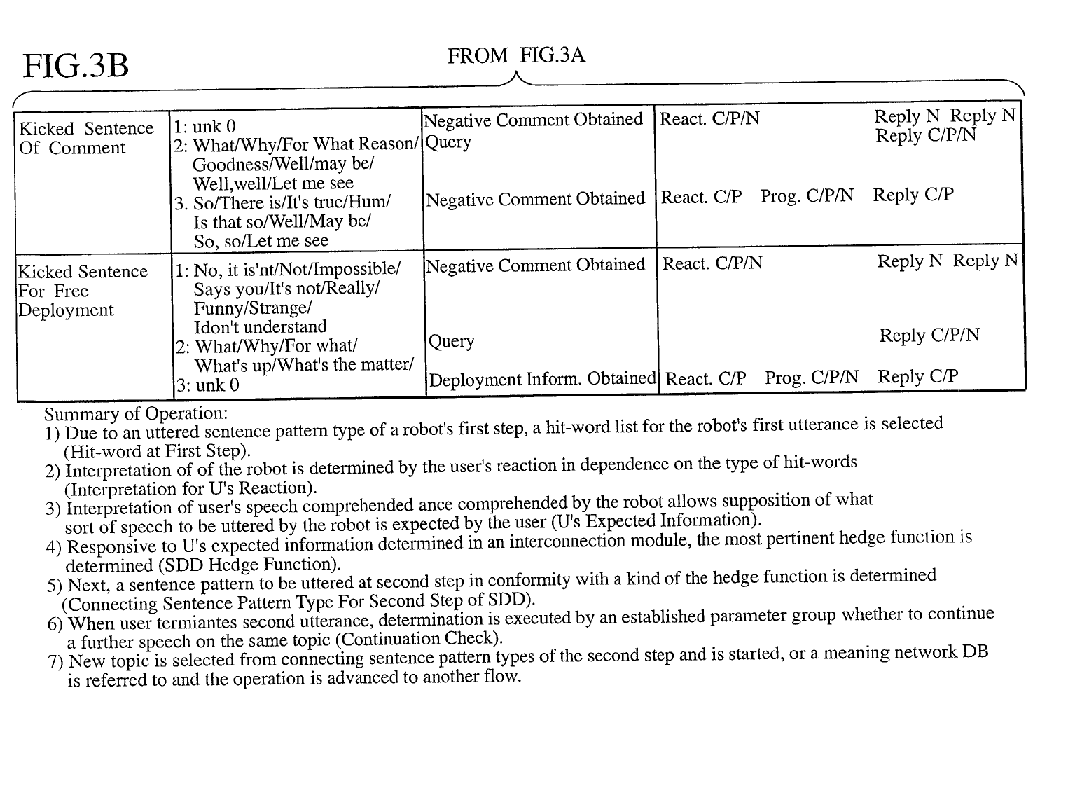

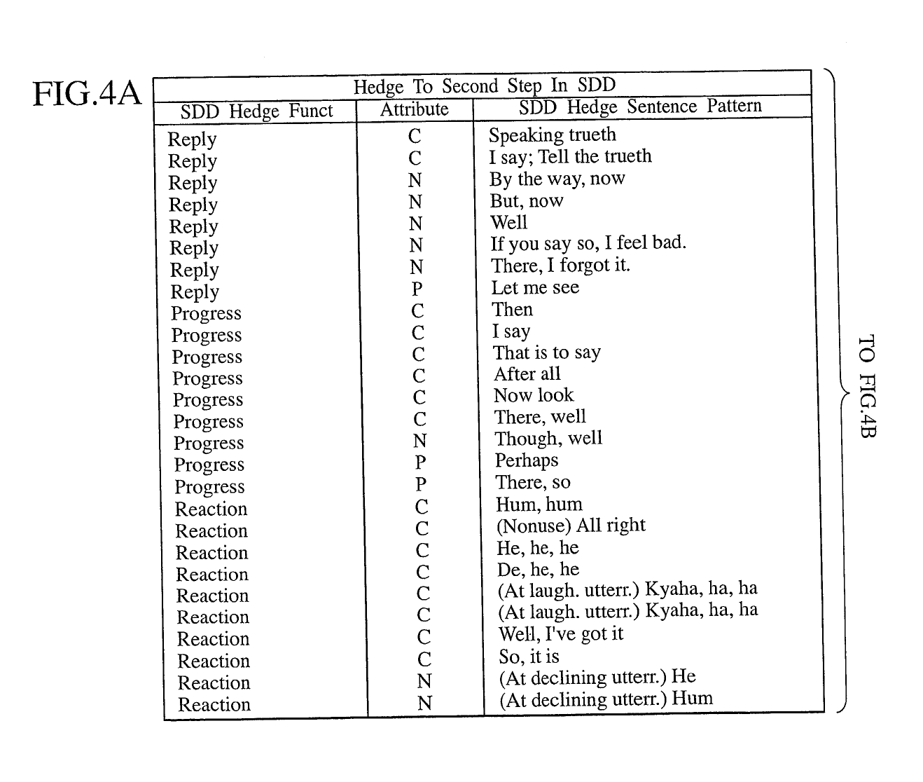

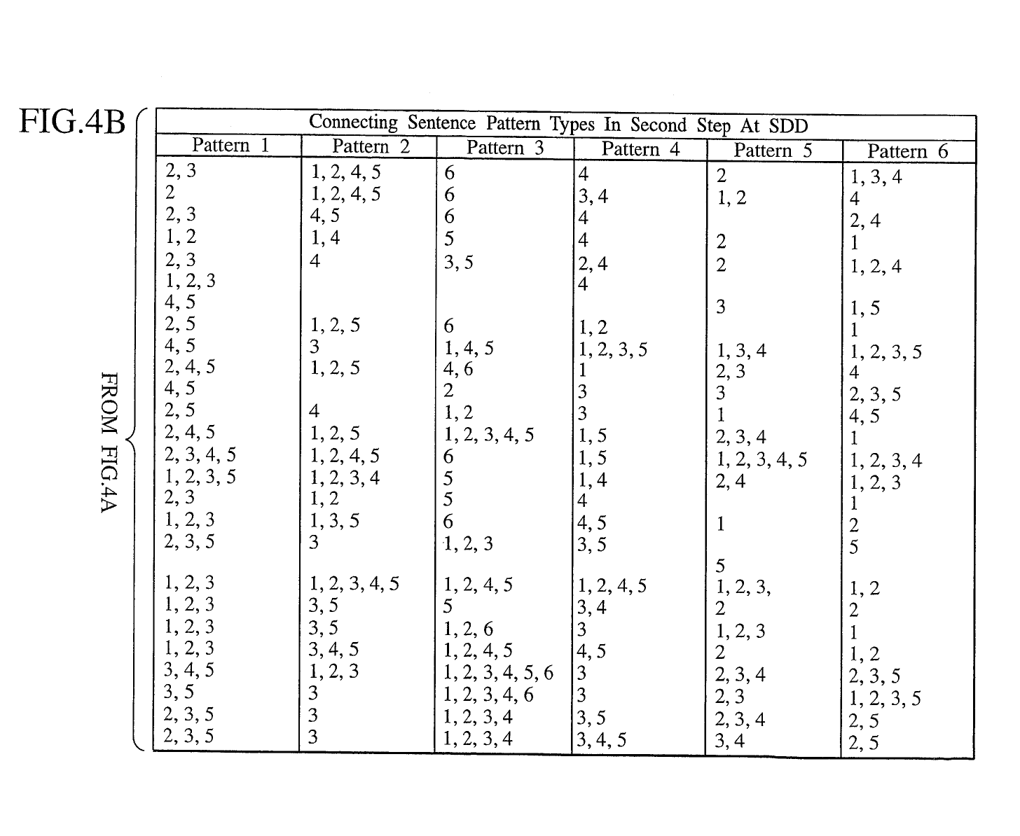

FIGS. 3A, 3B is a table illustrating the content of the interconnection module 40 in the SDD module 20, and FIG. 4A, 4B is a table illustrating a hedge connection in the SDD module, with reference symbols C, N and P designating “Neutral”, “Negative” and “Positive”.

In FIGS. 4A and 4B, pattern 1 to pattern 6 correspond to 1) the confirmation type sentence list to 5) the status quo setting type sentence list in FIGS. 2A, 2B, 2C and 2D. That is, when the first utterance of the robot involves (1) the confirmation type sentence, the pattern 1 is referred to for selecting the sentence construction pattern (representative of only numeral) that is able to form the second utterance of the robot. Similarly, the pattern 2 is referred to when the first utterance of the robot involves (2) the report type sentence, the pattern 3 is referred to when the first utterance of the robot involves (3) the query type sentence, the pattern 4 is referred to when the first utterance of the robot involves (4) the development type sentence, the pattern 5 is referred to when the first utterance of the robot involves (5) the turning type sentence and the pattern 6 is referred to when the first utterance of the robot involves (6) the status quo setting type sentence, thereby enabling the sentence construction patterns (representative of only numeral) that can be the second utterance of the robot to be selected, respectively.

As set forth above, the character type speak system 1 of the preferred embodiment is able to be realized as a character type speak robot, which remember language to freely speak, such as a communication robot having voice recognition, word spot function, artificial intelligence, automatic sentence forming function, single sound recognition and memory function. For example, if the user speak to the robot saying “It's a fine weather, today”, the word spot function of the voice recognition allows a string of key words, i.e. “today”, “fine” and “weather” to be recognized. This information allows the artificial intelligence to find out the related words to be used with the automatic sentence forming function through which a response is replied. Thus, the robot permits a flow of speech, with a sense of natural feeling, such as “It was a fine weather, yesterday” and “Fine weather makes me feel good”. Since the word spot function is effective to pick up not only a single word but also more than one two words as the recognized words and the artificial intelligence picks up the related words from the preceding string of speech, it is possible for responses different in any speech to be expected even in the presence of recognized words in the same combination.

Further, individual user's talking to the robot about their peculiar information allows the robot to store such peculiar information to be reflected in a subsequent string of speech, providing a capability in realization of a living speech with the user. Furthermore, the presence of an ability to store information like human to allow stored information to be reflected in a subsequent string of speech is likely to be effective for the robot to utter a string of speech, for example after one year, such as “You talked such a thing last year”. Moreover, the presence of the ability not only to store the string of words but also to be taught with a relevant schedule enables the robot to execute scheduled string of speeches on a regular basis at a flow of one day, a flow of one week or a flow of one year. For example, the robot may provide utterances such as “It's morning. Wake up” or “It's a day for collecting a garbage” or may provide a song “Happy birth day (user's name)”.

In addition, the use of lip synchronization through more than two comae per one character allows the robot to keep company with the user while providing a plentiful variation depending on the content of the string of speech and token languages.

In the future, the provision of expanded ability using ROM cassette or the use of coupling with a personal computer and a portable phone using a serial port enables a further progress in function.

Besides, the use of human type robot, a pet type robot like animal and the other type robot of any configuration as well as, for example, a personal computer and a portable phone enables the production of the character type speaking system 1 of the preferred embodiment.

As will be appreciated from the foregoing description, since the character type speak system of the preferred embodiment according to the present invention is so constructed to include the meaning network database storing a large number of words, the SDD module which enables the string of free sentences to be produced, the standardized topic module which allows deployment of the string of speech on the particular topic, and the interconnection module which enables continuous deployment of speech while maintaining and managing the discourse united property between the SDD module and the standardized topic module, it is possible for the speak system (speaking robot) per se to be constructed for realizing an autonomy and a discourse connecting property to serve as a discourse participant. This results in a capability of allowing the robot to learn a knowledge system related to the user through a conversation with the user for growing up a particular character in conformity with the content of the string of speech uttered by the user. Further, another advantage of the character type speak system concerns a capability of performing a conversation while autonomously developing and deploying a string of topics depending on user's reaction, the content of the utterance, the various words which are used, and timings.

In the preferred embodiment described above, further, while a description has been made in conjunction particularly with Japanese language, it is to be noted that the present invention is not limited to the discourse grammar of the Japanese language. That is, the SDD module which forms a part of the speak system of the present invention may be arranged to take advantage of various characteristic features in each discourse grammar of each language to the full to realize a discourse function with an autonomy with minimal discourse constraints.

The entire content of a Japanese Application No. P2001-70961 with a filing date of Mar. 13, 2001, is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

What is claimed is:

1. A character type speak system using a computer which allows a characteristic conversation with a user to be performed, comprising:
a meaning network database which stores a large number of words;
an SDD module which produces a string of free sentences;
a standardized topic module which allows a conversation to be deployed on a particular topic; and
an interconnection module which enables a continuous deployment of the conversation while maintaining and managing a discourse connecting property between the SDD module and the standardized topic module.

2. The character type speak system according to claim 1, wherein:
the meaning network database includes a noun table and a predicate table and has a given connecting property between words meaningfully correlated to one another.

3. The character type speak system according to claim 1, wherein:
the SDD module preliminarily contains a list of a plurality of kinds of sentence patterns and has a constraint function with respect to a discourse grammar in each language wherein, when producing an utterance sentence by embedding a noun or verb, necessary for an arbitrary topic, into an arbitrary sentence pattern, established information is omitted to preclude the presence of the same in the sentence.

4. The character type speak system according to claim 1, wherein:
the standardized topic module has a structure wherein stepwise information depths are allocated to a plurality of individual topics and a plurality of response sentences are prepared in the stepwise information depths, respectively.

5. The character type speak system according to claim 1, wherein:
the interconnection module has a hedge function for ensuring a connecting property between a user's utterance sentence and a robot's response sentence.

6. The character type speak system according to claim 1, further comprising:
a user information management module and a character management module.
